(19) United States
(12) Patent Application Publication
(10) Pub. No.: US 2019/0152805 A1
(43) Pub. Date: May 23, 2019

(54) REMOVAL OF PHOSPHOROUS FROM WATER USING WEAK BASE ANION EXCHANGE RESIN LOADED WITH ALUMINA

(71) Applicant: Dow Global Technologies LLC, Midland, MI (US)

(72) Inventors: Zheng Zhang, Shanghai (CN); Liu Yang, Shanghai (CN)

(73) Assignee: Dow Global Technologies LLC, Midland, MI (US)

(21) Appl. No.: 15/554,364

(22) PCT Filed: Apr. 25, 2016
(86) PCT No.: PCT/US2016/029119

§ 371 Date: Aug. 29, 2017

Related U.S. Application Data
(60) Provisional application No. 62/156,476, filed on May 4, 2015.

(51) Int. Cl. C02F 1/28; B01J 41/07; C02F 1/42; B01J 41/14; B01J 47/016

(52) U.S. Cl. CPC C02F 1/288; B01J 41/07; C02F 2101/105; B01J 41/14; B01J 47/016; C02F 1/42

(57) ABSTRACT

A method for treating water including phosphorus by passing the water through a bed weak base anion exchange resin to remove the phosphorous from the water, wherein the method is characterized by the resin being loaded with alumina.

### FIELD

The invention relates the use of weak base anion exchange resin to remove sources of phosphorous, namely phosphates, from waste water.

### INTRODUCTION

The presence of trace concentrations of phosphorous in lakes, reservoirs and other bodies of water can lead to eutrophication. The main sources of phosphorous include both organic and inorganic phosphates, often from detergents, fertilizers, industrial/domestic run-off, or sewage. One example is the “bloom” of phytoplankton in a water body in a response to increased levels of nutrients. Negative environmental effects include hypoxia, which may cause death to aquatic animals. A variety of techniques for removing phosphorous from such water bodies are known, including biological and physic-chemical treatments along with the use of fixed beds of adsorbents (e.g. alumina and zirconium oxides) and ion exchange resins. For example, U.S. Pat. No. 6,136,199 describes the use of a copper loaded chelating macroporous resins, e.g. DOWEX™ M4195 brand ion exchange resin—a macroporous chelating resin including a styrene-divinylbenzene matrix with chelation groups produced via reaction with bis-picolylamine The copper loaded resin was described as performing much better than a macroporous strong base anion resin (AMBERLITE™ IRA-958). U.S. Pat. No. 7,291,578 describes the use of both strong and weak base anion exchange resin (both gels and macroporous) loaded with iron and manganese to remove arsenic, chromate and phosphates. Similarly, U.S. Pat. No. 7,407,587 describes the use of metal oxide (iron oxide) loaded anion exchange resins for removing phosphate and arsenic from water. Strong base and weak base anion exchange resins are described along with gel and macroporous type resins. US2011/0155669 describes strong base macroporous resin loaded with iron oxide for removing phosphate. U.S. Pat. No. 7,588,744 describes a method for recovering the phosphate for subsequent use as a fertilizer. See also U.S. Pat. No. 3,931,003 (cellulose ion exchange resin impregnated with manganese dioxide) and U.S. Pat. No. 5,702,609.

### SUMMARY

The invention includes a method for treating water including phosphorus by passing the water through a bed of weak base anion exchange resin to remove the phosphorous from the water, wherein the method is characterized by the resin being loaded with alumina. The resin may be regenerated and the recovered phosphorous may be reused, e.g. as fertilizer.

### DETAILED DESCRIPTION

The water to be treated in the present method is not particularly limited and includes lakes, ponds, rivers, reservoirs and waste water from industrial, farming and municipal processes along with run-off and sewage. The method involves passing the water contaminated with phosphorous through one or more beds (e.g. columns) of an ion exchange resin. The design and operation of the bed(s) is not particularly limited. Packed, moving, and fluidized beds may be used. The water may be pre-treated to remove solids and other contaminates prior to practicing the subject method. For example, one or more of sedimentation, coagulation, flocculation, and filtration may be used as pretreatment.

The resin used in the present invention is an anion exchange resin, and more preferably a weak base macroporous anion exchange resin. Representative resins include: DOWEX™ MWA-1 and AMBERLYST™ 21 (weak base), both available from The Dow Chemical Company. The resin is loaded with alumina. Techniques for loaded resins with alumina are described in U.S. Pat. Nos. 4,430,311, 4,159,311 and 4,116,858, each of which is incorporated herein by reference. While these patents describe a subsequent reaction with LiCl which is not applicable to the present invention, the general description of the resin and loading technique are applicable. U.S. Pat. No. 7,407,587 also describes generally applicable metal loading techniques.

After adsorbing phosphorous, the resin may be regenerated, (e.g. with a solution of NaOH and NaCl), and phosphorous may be recovered, (e.g. reacted with a solution of NaOH and NaCl to form calcium phosphate) for reuse as fertilizer.

Applicable resin may be prepared according to well documented methods including the suspension polymerization of at least one monovinyl aromatic monomer (e.g. styrene) and a polyvinyl aromatic crosslinking monomer (e.g. divinylbenzene) to produce a crosslinked copolymer matrix that is subsequently sulfonated and converted to calcium form. The terms “microporous,” “gellular,” “gel” and “gel-type” are synonyms that describe copolymer particles having pore sizes less than about 20 Angstroms Å. In distinction, macroporous copolymer particles have both mesopores of from about 20 Å to about 500 Å and macropores of greater than about 500 Å. In a preferred embodiment, the resins used in the present invention are macroporous. Macroporous copolymer beads, as well as their preparation are described in U.S. Pat. Nos. 4,256,840 and 5,244,926. One preferred method is known in the art as a “seeded” polymerization, sometimes also referred to as batch or multi-batch (as generally described in EP 62088A1 and EP 179133A1); and continuous or semi-continuous staged polymerizations (as generally described in U.S. Pat. Nos. 4,419,245, 4,564,644 and 5,244,926). A seeded polymerization process typically adds monomers in two or more increments. Each increment is followed by complete or substantial polymerization of the monomers therein before adding a subsequent increment. A seeded polymerization is advantageously conducted as a suspension polymerization wherein monomers or mixtures of monomers and seed particles are dispersed and polymerized within a continuous suspending medium. In such a process, staged polymerization is readily accomplished by forming an initial suspension of monomers, wholly or partially polymerizing the monomers to form seed particles, and subsequently adding remaining monomers in one or more increments. Each increment may be added at once or continuously. Due to the insolubility of the monomers in the suspending medium and their solubility within the seed particles, the monomers are imbibed by the seed particles and polymerized therein. Multi-staged polymerization techniques can vary in the amount and type of monomers employed for each stage as well as the polymerizing conditions employed.

The seed particles employed may be prepared by known suspension polymerization techniques. In general the seed particles may be prepared by forming a suspension of a first monomer mixture in an agitated, continuous suspending medium as described by F. Helfferich in Ion Exchange, (McGraw-Hill 1962) at pp. 35-36. The first monomer mixture comprises: 1) a first monovinylidene monomer, 2) a first crosslinking monomer, and 3) an effective amount of a first free-radical initiator and optionally, 4) a phase-separating diluent. The suspending medium may contain one or more suspending agents commonly employed in the art. Polymerization is initiated by heating the suspension to a temperature of generally from about 50-90° C. The suspension is maintained at such temperature or optionally increased temperatures of about 90-150° C. until reaching a desired degree of conversion of monomer to copolymer. Other suitable polymerization methods are described in U.S. Pat. Nos. 4,444,961, 4,623,706, 4,666,673 and 5,244,926—each of which is incorporated herein in its entirety.

The monovinylidene aromatic monomers employed herein are well-known and reference is made to Polymer Processes, edited by Calvin E. Schildknecht, published in 1956 by Interscience Publishers, Inc., New York, Chapter III, “Polymerization in Suspension” at pp. 69-109. Table II (pp. 78-81) of Schildknecht lists diverse types of monomers which are suitable in practicing the present invention. Of the monomers listed, styrene and substituted styrene are preferred. The term “substituted styrene” includes substituents of either/or both the vinylidene group and phenyl group of styrene and include: vinyl naphthalene, alpha alkyl substituted styrene (e.g., alpha methyl styrene) alkylene-substituted styrenes (particularly monoalkyl-substituted styrenes such as vinyltoluene and ethylvinylbenzene) and halo-substituted styrenes, such as bromo or chlorostyrene and vinylbenzyl chloride. Additional monomers may be included along with the monovinylidene aromatic monomers, including monovinylidene non-styrenics such as: esters of α,β-ethylenically unsaturated carboxylic acids, particularly acrylic or methacrylic acid, methyl methacrylate, isobornyl-methacrylate, ethylacrylate, and butadiene, ethylene, propylene, acrylonitrile, and vinyl chloride; and mixtures of one or more of said monomers. Preferred monovinylidene monomers include styrene and substituted styrene such as ethylvinylbenzene. The term “monovinylidene monomer” is intended to include homogeneous monomer mixtures and mixtures of different types of monomers, e.g. styrene and isobornylmethacrylate. The seed polymer component preferably comprises a styrenic content greater than 50 molar percent, and more preferably greater than 75, and in some embodiments greater than 95 molar percent (based upon the total molar content). The term “styrenic content” refers to the quantity of monovinylidene monomer units of styrene and/or substituted styrene utilized to form the copolymer. “Substituted styrene” includes substituents of either/or both the vinylidene group and phenyl group of styrene as described above. In preferred embodiments, the first monomer mixture used to form the first polymer component (e.g. seed) comprises at least 75 molar percent, preferably at least 85 molar percent and in some embodiments at least 95 molar percent of styrene.

Examples of suitable crosslinking monomers (i.e., polyvinylidene compounds) include polyvinylidene aromatics such as divinylbenzene, divinyltoluene, divinylxylene, divinylnaphthalene, trivinylbenzene, divinyldiphenylsulfone, as well as diverse alkylene diacrylates and alkylene dimethacrylates. Preferred crosslinking monomers are divinylbenzene, trivinylbenzene, and ethylene glycol dimethacrylate. The terms “crosslinking agent,” “crosslinker” and “crosslinking monomer” are used herein as synonyms and are intended to include both a single species of crosslinking agent along with combinations of different types of crosslinking agents. The proportion of crosslinking monomer in the copolymer seed particles is preferably sufficient to render the particles insoluble in subsequent polymerization steps (and also on conversion to an ion-exchange resin), yet still allow for adequate imbibition of an optional phase-separating diluent and monomers of the second monomer mixture. In some embodiments, no crosslinking monomer will be used. Generally, a suitable amount of crosslinking monomer in the seed particles is minor, i.e., desirably from about 0.01 to about 12 molar percent based on total moles of monomers in the first monomer mixture used to prepare the seed particles. In a preferred embodiment, the first polymer component (e.g. seed) is derived from polymerization of a first monomer mixture comprising at least 85 molar percent of styrene (or substituted styrene such as ethylvinylbenzene) and from 0.01 to about 10 molar percent of divinylbenzene.

Polymerization of the first monomer mixture may be conducted to a point short of substantially complete conversion of the monomers to copolymer or alternatively, to substantially complete conversion. If incomplete conversion is desired, the resulting partially polymerized seed particles advantageously contain a free-radical source therein capable of initiating further polymerization in subsequent polymerization stages. The term “free-radical source” refers to the presence of free-radicals, a residual amount of free-radical initiator or both, which is capable of inducing further polymerization of ethylenically unsaturated monomers. In such an embodiment of the invention, it is preferable that from about 20 to about 95 weight percent of the first monomer mixture, based on weight of the monomers therein, be converted to copolymer and more preferably from about 50 to about 90 weight percent. Due to the presence of the free radical source, the use of a free-radical initiator in a subsequent polymerization stage would be optional. For embodiments where conversion of the first monomer mixture is substantially complete, it may be necessary to use a free-radical initiator in subsequent polymerization stages.

The free-radical initiator may be any one or a combination of conventional initiators for generating free radicals in the polymerization of ethylenically unsaturated monomers. Representative initiators are UV radiation and chemical initiators, such as azo-compounds including azobisisobutyronitrile; and peroxygen compounds such as benzoyl peroxide, t-butylperoctoate, t-butylperbenzoate and isopropylpercarbonate. Other suitable initiators are mentioned in U.S. Pat. Nos. 4,192,921, 4,246,386 and 4,283,499—each of which is incorporated in its entirety. The free-radical initiators are employed in amounts sufficient to induce polymerization of the monomers in a particular monomer mixture. The amount will vary as those skilled in the art can appreciate and will depend generally on the type of initiators employed, as well as the type and proportion of monomers being polymerized. Generally, an amount of from about 0.02 to about 2 weight percent is adequate, based on total weight of the monomer mixture.

The first monomer mixture used to prepare the seed particles is advantageously suspended within an agitated suspending medium comprising a liquid that is substantially immiscible with the monomers, (e.g. preferably water). Generally, the suspending medium is employed in an amount from about 30 to about 70 and preferably from about 35 to about 50 weight percent based on total weight of the monomer mixture and suspending medium. Various suspending agents are conventionally employed to assist with maintaining a relatively uniform suspension of monomer droplets within the suspending medium. Illustrative suspending agents are gelatin, polyvinyl alcohol, magnesium hydroxide, hydroxyethylcellulose, methylhydroxyethyl cellulose methylcellulose and carboxymethyl methylcellulose. Other suitable suspending agents are disclosed in U.S. Pat. No. 4,419,245. The amount of suspending agent used can vary widely depending on the monomers and suspending agents employed. Latex inhibitors such as sodium dichromate may be used to minimize latex formation.

In the so-called “batch-seeded” process, seed particles comprising from about 10 to about 50 weight percent of the copolymer are preferably suspended within a continuous suspending medium. A second monomer mixture containing a free radical initiator is then added to the suspended seed particles, imbibed thereby, and then polymerized. Although less preferred, the seed particles can be imbibed with the second monomer mixture prior to being suspended in the continuous suspending medium. The second monomer mixture may be added in one amount or in stages. The second monomer mixture is preferably imbibed by the seed particles under conditions such that substantially no polymerization occurs until the mixture is substantially fully imbibed by the seed particles. The time required to substantially imbibe the monomers will vary depending on the copolymer seed composition and the monomers imbibed therein. However, the extent of imbibition can generally be determined by microscopic examination of the seed particles, or suspending media, seed particles and monomer droplets. The second monomer mixture desirably contains from about 0.5 to about 25 molar percent, preferably from about 2 to about 17 molar percent and more preferably 2.5 to about 8.5 molar percent of crosslinking monomer based on total weight of monomers in the second monomer mixture with the balance comprising a monovinylidene monomer; wherein the selection of crosslinking monomer and monovinylidene monomer are the same as those described above with reference to the preparation of the first monomer mixture, (i.e. seed preparation). As with the seed preparation, the preferred monovinylidene monomer includes styrene and/or a substituted styrene. In a preferred embodiment, the second polymer component (i.e. second monomer mixture, or “imbibed” polymer component) has a styrenic content greater than 50 molar percent, and more preferably at least 75 molar percent (based upon the total molar content of the second monomer mixture). In a preferred embodiment, the second polymer component is derived from polymerization of a second monomer mixture comprising at least 75 molar percent of styrene (and/or substituted styrene such as ethylvinylbenzene) and from about 1 to 20 molar percent divinylbenzene.

In an in-situ batch-seeded process, seed particles comprising from about 10 to about 80 weight percent of the copolymer product are initially formed by suspension polymerization of the first monomer mixture. The seed particles can have a free-radical source therein as previously described, which is capable of initiating further polymerization. Optionally, a polymerization initiator can be added with the second monomer mixture where the seed particles do not contain an adequate free radical source or where additional initiator is desired. In this embodiment, seed preparation and subsequent polymerization stages are conducted in-situ within a single reactor. A second monomer mixture is then added to the suspended seed particles, imbibed thereby, and polymerized. The second monomer mixture may be added under polymerizing conditions, but alternatively may be added to the suspending medium under conditions such that substantially no polymerization occurs until the mixture is substantially fully imbibed by the seed particles. The composition of the second monomer mixture preferably corresponds to the description previously given for the batch-seeded embodiment.

The copolymer may be functionalized by classic chloromethylation followed by animation. Techniques for conducting a chloromethylation reaction are described by G. Jones, “Chloromethylation of Polystyrene,” Industrial and Engineering Chemistry, Vol. 44, No. 1, pgs. 2686-2692, (November 1952), along with US 2008/0289949 and U.S. Pat. No. 6,756,462—each of which are incorporated herein in their entirety. Chloromethylation is typically conducted by combining the polymer with a chloromethylation reagent in the presence of a catalyst at a temperature of from about 15 to 100° C., preferably 35 to 70° C. for about 1 to 8 hours. A preferred chloromethylation reagent is chloromethyl methyl ether (CMME); however, other reagents may be used including CMME-forming reactants such as the combination of formaldehyde, methanol and hydrogen chloride or chlorosulfonic acid (as described in US 2004/0256597), or hydrogen chloride with methylated formalin The chloromethylating reagent is typically combined with the polymer in an amount of from about 0.5 to 20, preferably about 1.5 to 8 mole of CMME per mole of polymer. While less preferred, other chloromethylation reagents may be used including but not limited to: bis-chloromethyl ether (BCME), BCME-forming reactants such as formaldehyde and hydrogen chloride, and long chain alkyl chloromethyl ethers as described in U.S. Pat. No. 4,568,700.

Catalyst useful for conducting chloromethylation reactions are well known and are often referred to in the art as “Lewis acid” or “Friedel-Crafts” catalyst. Non-limiting examples include: zinc chloride, zinc oxide, ferric chloride, ferric oxide, tin chloride, tin oxide, titanium chloride, zirconium chloride, aluminum chloride and sulfuric acid along with combinations thereof. Halogens other than chloride may also be used in the preceding examples. A preferred catalyst is ferric chloride. The catalyst is typically used in an amount corresponding to about 0.01 to 0.2, preferably from about 0.02 to 0.1 mole catalyst per mole of polymer repeating unit. Catalyst may be used in combination with optional catalyst adjuncts such as calcium chloride and activating agents such as silicon tetrachloride. More than one catalyst may be used to achieve the desired chloromethylation reaction profile.

Solvents and/or swelling agents may also be used in the chloromethylation reaction. Examples of suitable solvents including but are not limited to one or more of: an aliphatic hydrocarbon halides such as ethylene dichloride, dichloropropane, dichloromethane, chloroform, diethyl ether, dipropyl ether, dibutyl ether and diisoamyl ether. When CMME is used as the chloromethylation agent, such solvents and/or swelling agents are often not necessary.

Amination of the chloromethylated resin may be accomplished by classic techniques including those described in: U.S. Pat. Nos. 5,134,169, 6,756,462, 6,924,317, 7,282,153, 8,273,799 and US 2004/0256597. Aminations may be performed using primary, secondary or tertiary amines, or combinations; see for example U.S. Pat. No. 5,141,965 which discloses a sequential amination a primary or secondary amine followed by a subsequent amination with a tertiary amine, U.S. Pat. No. 3,317,313 which discloses a sequential amination including a first amination with a tertiary amine followed by an amination with a secondary amine, and U.S. Pat. No. 6,059,975 which discloses amination with a tertiary amine having relatively large (≥C5) alkyl groups followed by a second amination with a tertiary amine having smaller alkyl groups. The entire subject matter of each of the US patents listed above is incorporated herein by reference. As mentioned, the subject resins are preferably weak base anion exchange resins. As used herein, the term “weak base” refers to anion exchange resins including a tertiary amine functional group. Anion exchange resins particularly suited in the present invention can have functional amine groups which are substantially all of the weak base variety, or and some which contain both strong base and weak base varieties. For purposes of this disclosure, anion exchange resin containing any groups of the weak base variety are generally referred to as “weak base.”

Alumina may be loaded in the subject anion exchange resin using classic techniques as described in U.S. Pat. Nos. 7,407,587, 4,430,311, 4,159,311 and 4,116,858. As used herein, the term “alumina” refers to oxides of aluminum including Al₂O₃. In brief, the anion exchange resin is preferable converted to the chloride form (e.g. soaking in HCl) followed by washing and draining the resin. The resin is then soaked with a saturated (30-33%) aqueous solution of AlCl₃ or a hydrate (AlCl₃.6H₂O). The resin is then removed and combined with an ammonia (>27%) solution followed by washing of the resin with deionized water. The resin may then be optionally combined with a solution of NaAlO2, NaOH and HCl with the temperature of the solution being maintained at less than 40° C. The resin is then washed with deionized water and soaked in a NaCl solution until use.

The subject anion exchange resin is preferably provided in bead form having a median diameter from 10 to 2000 microns, and preferably from 100 to 1000 microns, and more preferably from 150 to 500 microns. The beads may have a Gaussian particle size distribution or may have a relatively uniform particle size distribution, i.e. “monodisperse” that is, at least 90 volume percent of the beads have a particle diameter (“uniformity”) from about 0.8 to about 1.2, and more preferably 0.85 to 1.15 times the volume average particle diameter.

### EXAMPLES

Five commercially available anion exchange resins were obtained from The Dow Chemical Company. Each resin was converted to its chloride form and loaded with alumina as per the procedure described above. Each resin was tested by adding a 0.5 mg sample into a beaker filled with 250 ml of test water containing 0.79 ppm of phosphorous. Each beaker was shaken for approximately 8 hours, after which the water in each beaker was tested for phosphorous content (via the standard spectrophotometric method GB 11893-89). Results are summarized in Table 1. As shown, the weak base anion exchange resins provided superior results as compared with strong base resins.
Resin samples:
A AMBERLYST™ 21 (weak base macroporous)
B DOWEX™ MWA-1 (weak base macroporous)
C DOWEX™ MSA (type 1 strong base, macroporous)
D AMBERLITE™ 958C1 (strong base macroporous, acrylic)
E AMBERLITE™p0 900C1 (type 1 strong base macroporous)

TABLE 1

| Resin Sample | A | B | C | D | E |
|---|---|---|---|---|---|
| Total Phosphorous (mg/L) | 0 | 0 | 0.4 | 0.3 | 0.4 |
| Removal Ratio | 92.3 | 95.0 | 50.6 | 60.1 | 49.4 |

1. A method for treating water including phosphorus by passing the water through a bed of weak base anion exchange resin to remove the phosphorous from the water, wherein the method is characterized by the resin being loaded with alumina.

2. The method of claim 1 wherein the anion exchange resin is a macroporous polymer.

3. The method of claim 1 wherein the polymer is a copolymer derived from styrene and divinylbenzene.

4. The method of claim 1 further including the step of regenerating the resin and recovering the phosphorous.

5. The method of claim 1 wherein the phosphorous comprises a phosphate.
